(19) United States
(12) Patent Application Publication
(10) Pub. No.: US 2026/0285149 A1
(43) Pub. Date: Sep. 24, 2026

(54) ELECTRIC VEHICLE AND CORRESPONDING CONTROL SYSTEM

(71) Applicant: FORD GLOBAL TECHNOLOGIES, LLC, Dearborn, MI (US)

(72) Inventors: Guopeng HU, Northville, MI (US); Zhengyu DAI, Canton, MI (US); Matthew John SHELTON, Grosse Ile, MI (US); Yanan ZHAO, Ann Arbor, MI (US); Thirumal NAGADI, Troy, MI (US); Ankit SAINI, Novi, MI (US)

(21) Appl. No.: 19/087,853

(22) Filed: Mar. 24, 2025

(51) Int. Cl. B60K 23/08; B60K 1/02; B60K 17/02; B60K 17/06; B60K 17/356; B60L 15/20

(52) U.S. Cl. CPC B60K 23/0808; B60K 1/02; B60K 17/02; B60K 17/06; B60L 15/20; B60K 17/356; B60K 2023/085; B60L 2240/12; B60L 2240/14; B60L 2240/423; B60L 2250/28

(57) ABSTRACT

A vehicle includes a first electric machine, a second electric machine, a transmission, and a controller. The first and second electric machines are operable to deliver torque to first and second drive wheels, respectively. The transmission is operable to deliver the torque from the first electric machine to the first drive wheel. The transmission is further operable to shift between first and second gear ratios. The controller is programmed to decrease the torque of the first electric machine and increase the torque of the second electric machine prior to shifting the transmission from the first gear ratio to the second gear ratio.

### TECHNICAL FIELD

The present disclosure relates to hybrid and electric vehicles and powertrain systems for hybrid and electric vehicles.

### BACKGROUND

Hybrid and electric vehicles may be propelled by one or more electric machines that draw power from a battery.

### SUMMARY

A vehicle includes a first electric machine, a second electric machine, a transmission, and a controller. The controller is programmed to, for a given vehicle speed at which clutches of the transmission initiate a gear change, initiate adjustment of torques of the first and second electric machines prior to the gear change at a target vehicle speed that is less than the given vehicle speed. The target vehicle speed is greater as a result of vehicle acceleration deviating from a range as compared with the vehicle acceleration remaining within the range.

A vehicle includes a first electric machine, a second electric machine, a transmission, and a controller. The first and second electric machines are operable to deliver torque to drive wheels. The transmission is operable to deliver the torque from the first electric machine to a first of the drive wheels. The transmission has clutches operable to adjust a gear ratio between the first electric machine and the first of the drive wheels. The controller is programmed to, as a result of an acceleration of the vehicle and the acceleration deviating from a tolerance, decrease the torque of the first electric machine and increase the torque of the second electric machine at a first vehicle speed that is less than a threshold speed. The threshold speed corresponds to a vehicle speed where a first of the clutches disengages to initiate a change in the gear ratio between the first electric machine and the first of the drive wheels. The controller is further programmed to as a result of the acceleration of the vehicle and the acceleration of the vehicle remaining within a tolerance, decrease the torque of the first electric machine and increase the torque of the second electric machine at a second vehicle speed that is less than the first vehicle speed.

A vehicle includes a first electric machine, a second electric machine, a transmission, and a controller. The first and second electric machines are operable to deliver torque to first and second drive wheels, respectively. The transmission is operable to deliver the torque from the first electric machine to the first drive wheel. The transmission is further operable to shift between first and second gear ratios. The controller is programmed to, as a result of, an acceleration of the vehicle toward a threshold speed, a time duration to increase a vehicle speed from a current speed to the threshold speed being less than a time threshold, and a rate of change in a position of an accelerator pedal being less than a threshold rate, decrease the torque of the first electric machine and increase the torque of the second electric machine prior to the vehicle attaining the threshold speed followed by shifting the transmission from the first gear ratio to the second gear ratio. The controller is further programmed to as a result of, the acceleration of the vehicle toward the threshold speed, the time duration being less than the time threshold, and the rate of change in the position of the accelerator pedal exceeding the threshold rate, decrease the torque of the first electric machine and increase the torque of the second electric machine upon the vehicle attaining the threshold speed followed by shifting the transmission from the first gear ratio to the second gear ratio.

### BRIEF DESCRIPTION OF THE DRAWINGS

FIG. 1 is a schematic illustration of a representative powertrain of an electric vehicle;

FIG. 2 is a set of graphs illustrating various states of the electric vehicle, such as vehicle speed, vehicle acceleration, torques of electric motors connected to drive units, etc., during a transmission shift;

FIGS. 3A and 3B correspond to a flowchart that is representative of a method for controlling the torque outputs of primary and second drive units during the transmission shift;

FIG. 4 is a set of graphs illustrating controlling the torque outputs of the primary and secondary drive units during a proactive shift under a first set of conditions;

FIG. 5 is a set of graphs illustrating controlling the torque outputs of the primary and secondary drive units during a proactive shift under a second set of conditions;

FIG. 6 is a graph illustrating an accelerator pedal position relative to vehicle speed; and

FIG. 7 is a graph illustrating a torque output limit of a secondary drive unit relative vehicle speed.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

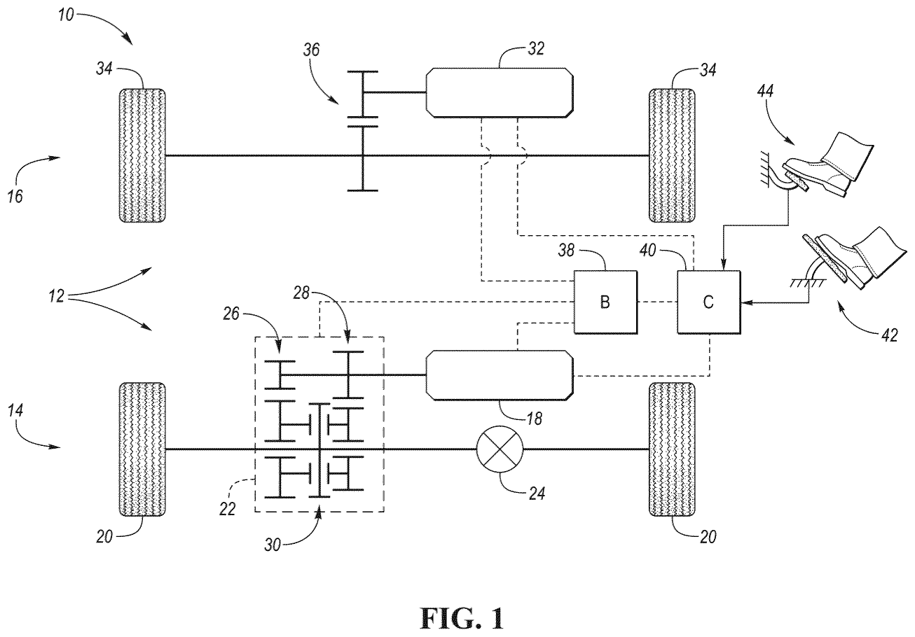

Referring to FIG. 1, a schematic diagram of an electric vehicle 10 is illustrated according to an embodiment of the present disclosure. FIG. 1 illustrates representative relationships among the components. Physical placement and orientation of the components within the vehicle may vary. The electric vehicle 10 includes a powertrain 12. The powertrain 12 includes a primary drive unit (PDU) 14 and a secondary drive unit (SDU) 16. The PDU 14 may correspond to a first axle of the electric vehicle 10 while the SDU 16 may correspond to a second axle of the electric vehicle 10.

The PDU 14 includes a first electric machine 18 that is operable to deliver torque to one or more drive wheels 20. The PDU 14 may further include a gearbox or transmission 22 and a differential 24 that are each disposed between the first electric machine 18 and the drive wheels 20. Shafts, constant velocity joints, universal joints, or other connecting elements may be disposed between and operable to connect the elements of the PDU 14 (e.g., first electric machine 18, transmission 22, differential 24, drive wheels 20, etc.) to each other. The transmission 22 may include gears that are operable to provide multiple gear ratios between an input to and an output from the transmission 22. The first electric machine 18 may be connected to the input to the transmission 22 and the drive wheels 20 may be connected to the output from the transmission 22.

A first set of the gears 26 when connect to the output of the transmission 22 provides a first gear ratio and a second set of the gears 28 when connect to the output of the transmission 22 provides a second gear ratio. The first set of gears 26 may be referred to as the first gear of the transmission 22 and the second set of gears 28 may be referred to as the second gear ratio of the transmission 22. The first set of gears 26 may provide a larger gear ratio between the input and output of the transmission 22 relative to the second set of gears 26.

One or more clutches 30 may be operable to connect and disconnect the first set of gears 26 and the second set of gears 28 to and from the output of the transmission 22. The one or more clutches 30 may be dog clutches. The one or more clutches 30 may comprise one clutch (as shown) that transitions between connecting the first set of gears 26 and the second set of gears 28 to the output of the transmission 22. Alternatively, the one or more clutches 30 may comprise two clutches that are connected to the first set of gears 26 and the second set of gears 28, respectively, so that the first set of gears 26 and the second set of gears 28 may be independently connected to and disconnected from the output of the transmission 22. An actuator, such a brushless DC (BLDC) motor with fork to move the shifting plate of the one or more clutches, hydraulic piston, or electric solenoid, may be operable to engage, disengage, or shift the one or more clutches 30. A valve that is operated by an electric solenoid may be configured to direct fluid to such a hydraulic piston to operate such a hydraulic piston if the one or more clutches 30 are operated by such a hydraulic piston.

The differential 24 transmits approximately equal torque to each wheel 20 while permitting slight speed differences such as when the vehicle 10 turns a corner. Different types of differentials or similar devices may be used to distribute torque from the powertrain to one or more wheels. In some applications, torque distribution may vary depending on the particular operating mode or condition, for example.

The SDU 16 includes a second electric machine 32 that is operable to deliver torque to one or more drive wheels 34. The SDU 16 may further include a third set of gears 36 disposed between the second electric machine 32 and the one or more drive wheels 34. The third set of gears 36 may provide a gear reduction between the second electric machine 32 and the one or more drive wheels 34. Shafts, constant velocity joints, universal joints, or other connecting elements may be disposed between and operable to connect the elements of the SDU 16 (e.g., the second electric machine 32, drive wheels 34, etc.) to each other.

The first electric machine 18 and the second electric machine 32 are drive sources for the electric vehicle 10 that are configured to propel the electric vehicle 10. The first electric machine 18 and the second electric machine 32 may be implemented by any one of a plurality of types of electric machines. For example, the first electric machine 18 and the second electric machine 32 may be a permanent magnet synchronous motors. Power electronics may condition direct current (DC) power provided by a battery 38 to the requirements of the first electric machine 18 and the second electric machine 32, as will be described below. For example, the power electronics may provide three phase alternating current (AC) to the first electric machine 18 and the second electric machine 32.

The powertrain 12 further includes an associated controller 40 such as a powertrain control unit (PCU). While illustrated as one controller, the controller 40 may be part of a larger control system and may be controlled by various other controllers throughout the vehicle 10, such as a vehicle system controller (VSC). It should therefore be understood that the powertrain control unit 40 and one or more other controllers can collectively be referred to as a “controller” that controls various actuators in response to signals from various sensors to control functions such as operating the first electric machine 18 and the second electric machine 32 to provide wheel torque or charge the battery 38, select or schedule transmission shifts, etc. Controller 40 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the vehicle 10.

The controller 40 communicates with various vehicle sensors and actuators via an input/output (I/O) interface (including input and output channels) that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. As generally illustrated in the representative embodiment of FIG. 1, controller 40 may communicate signals to and/or receive signals from the first electric machine 18, the second electric machine 32, battery 38, transmission 22, power electronics, and any another component of the powertrain 12 that may be included, but is not shown in FIG. 1. Although not explicitly illustrated, those of ordinary skill in the art will recognize various functions or components that may be controlled by controller 40 within each of the subsystems identified above. For example, the controller 40 may be configured to operate the actuators that controls the one or more clutches 30 to adjust the gear ratio between the input and output of the transmission 22. Representative examples of parameters, systems, and/or components that may be directly or indirectly actuated using control logic and/or algorithms executed by the controller 40 include front-end accessory drive (FEAD) components such as an alternator, air conditioning compressor, battery charging or discharging, regenerative braking, operation of the first electric machine 18, operation of the second electric machine 32, clutch pressures for the transmission 22 or any other clutch that is part of the powertrain 12, and the like. Sensors communicating input through the I/O interface may be used to indicate wheel speeds (WS1, WS2), vehicle speed (VSS), coolant temperature (ECT), accelerator pedal position (PPS), vehicle acceleration, ignition switch position (IGN), ambient air temperature, transmission gear, ratio, or mode, transmission oil temperature (TOT), transmission input and output speed, shift mode (MDE), battery temperature, voltage, current, or state of charge (SOC) for example.

Control logic or functions performed by controller 40 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based vehicle and/or powertrain controller, such as controller 40. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle 10 or its subsystems. The computer-readable storage devices or media may include one or more of a number of known physical devices which utilize electric, magnetic, and/or optical storage to keep executable instructions and associated calibration information, operating variables, and the like.

An accelerator pedal 42 is used by the driver of the vehicle 10 to provide a demanded torque, power, or drive command to the powertrain 12 (or more specifically to provide a demanded torque, power, or drive command to o the first electric machine 18 and/or the second electric machine 32) to propel the vehicle. In general, depressing and releasing the accelerator pedal 42 generates an accelerator pedal position signal that may be interpreted by the controller 40 as a demand for increased or decreased power, respectively. A brake pedal 44 is also used by the driver of the vehicle 10 to provide a demanded braking torque to slow the vehicle 10. In general, depressing and releasing the brake pedal 44 generates a brake pedal position signal that may be interpreted by the controller 40 as a demand to decrease the vehicle speed. Based upon inputs from the accelerator pedal 42 and brake pedal 44, the controller 40 commands the torque and/or power to the first electric machine 18, the second electric machine 32, and friction brakes. The controller 40 also controls the timing of gear shifts within the transmission 22.

The first electric machine 18 and the second electric machine 32 may act as a motors and provide driving forces for the powertrain 12. To drive the vehicle with the first electric machine 18 and the second electric machine 32, the traction battery 38 transmits stored electrical energy through wiring to the power electronics that may include inverter and rectifier circuitry, for example. The inverter circuitry of the power electronics may convert DC voltage from the battery 38 into AC voltage to be used by the first electric machine 18 and/or the second electric machine 32. The rectifier circuitry of the power electronics may convert AC voltage from the first electric machine 18 and/or the second electric machine 32 into DC voltage to be stored with the battery 38. The controller 40 commands the power electronics to convert voltage from the battery 38 to an AC voltage provided to the first electric machine 18 and the second electric machine 32 to provide positive or negative torque.

The first electric machine 18 and the second electric machine 32 may also act as generators and convert kinetic energy from the powertrain 12 into electric energy to be stored in the battery 38. More specifically, the first electric machine 18 and the second electric machine 32 may act as generators during times of regenerative braking in which torque and rotational (or kinetic) energy from the spinning wheels (e.g., drive wheels 20 or drive wheels 34) is transferred back through the powertrain 12 and to the first electric machine 18 and/or the second electric machine 32, which is then is converted into electrical energy for storage in the battery 38.

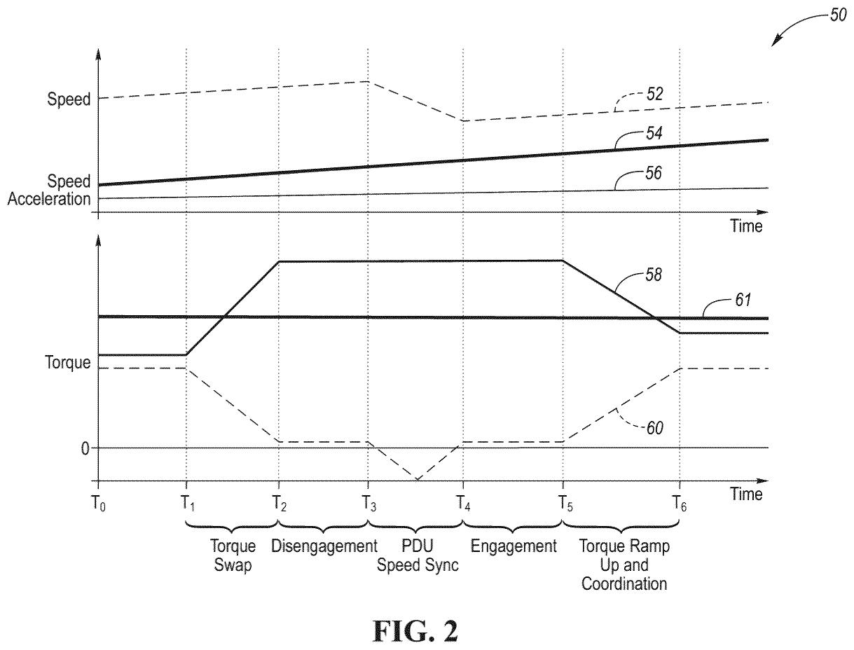

Referring to FIG. 2, a set of graphs 50 of various states of the electric vehicle 10, such as vehicle speed, vehicle acceleration, torques of electric motors connected to drive units, etc., during a transmission shift are illustrated. FIG. 2 is an example of how the vehicle operates during a shift in the transmission 22 from the first gear to the second gear. The speed of the motor of the PDU 14 (i.e., the first electric machine 18) is illustrated as line 52, the speed of the vehicle 10 is illustrated as line 54, the acceleration of the vehicle 10 is illustrated as line 56, the torque of the of the motor of the SDU 16 (i.e., the second electric machine 32) is illustrated as line 58, the torque of the of the motor of the PDU 14 (i.e., the first electric machine 18) is illustrated as line 60, and the total or combined torque output of the PDU 14 and SDU 16 are illustrated by line 61. It is noted that the total or combined torque output of the PDU 14 and SDU 16 remains constant in the example in FIG. 2, which is desirable since there are no sudden changes in torque during the shift that could affect feel and drivability.

The vehicle acceleration 56 remains relatively constant from time T₀ to T₆ throughout this example while the vehicle speed 54 increases at a constant rate from time T₀ to T₆. Between time T₀ and T₁, the torque of the SDU motor 58 and the torque of the PDU motor 60 remain constant. At the end of this period at time T₁, a command is generated to shift the transmission 22 from the first gear to the second gear (e.g., a command to upshift the transmission 22 is generated) due to the increase in vehicle speed 54. During the shift of the transmission 22 the first electric machine 18 will be temporarily disconnected from the transmission 22 and ultimately from the drive wheels 20 due to the operation of the one or more clutches 30. Furthermore, it may be advantageous to decrease the torque of the first electric machine 18 so that the one or more clutches 30 engages and transitions the transmission 22 to the second gear in a zero or low torque scenario to limit stress on the one more clutches 30 and the other elements of the PDU 14.

In order to maintain delivery of a consistent total torque to the drive wheels (i.e., the total torque being delivered to drive wheels 20 and drive wheels 34) during the shift, the torque of the second electric machine 32 is increased while the torque of the first electric machine 18 is decrease, preferably to zero, during a torque swap phase, which occurs between time T₁ and T₂. The off-going clutch of the one or more clutches 30 is then disengaged between times T₂ and T₃.

Next, between times T₃ and T₄, the speed of the first electric machine 18 is operated to sync with the elements corresponding to the second gear in the transmission (e.g., the speed of oncoming clutch of the one or more clutches 30 and/or the speed of the second set of the gears 28). More specifically, between times T₃ and T₄, the speed of the first electric machine 18 may decrease and the torque of the first electric machine 18 may transition to a negative value that first ramps down below zero and then transitions back up to zero at time T₄. The transmission 22 may be said to be in neutral between times T₃ and T₄. It is noted that the speed of the first electric machine may have steadily increased between times T₀ and T₃.

Next, between times T₄ and T₅, the speed the oncoming clutch of the one or more clutches 30 is then engaged between times T₄ and T₅. Once the oncoming clutch of the one or more clutches 30 is then engaged, the torque of the first electric machine 18 is ramped up and the torque of the second electric machine 32 is ramped down between times T₅ and T₆ to desired values. The first electric machine 18 and the second electric machine 32 are then operated at the desired valves after time T₆. The speed of the first electric machine 18 will once again increase after time T₄ as illustrated as long as the vehicle speed 54 continues increase as illustrated.

The torque swap phase between times T₁ and T₂ ensures PDU torque is at or near zero before the shift occurs. The overall gear shift time may include the torque swap time. To reduce the overall shift time, the torque swap time should be as short as possible. However, the PDU and SDU motors (e.g., the first electric machine18 and the second electric machine 32) have motor torque slew rates, which operate as constraints. The torque slew rates cannot be too high, otherwise there will be vehicle stability and driveline oscillation issues. Also, swapping the SDU and PDU torque quickly and smoothly is important. The solution described herein includes implementing a proactive torque swap before the shift command is generated. The proactive shift command is based on prediction of the gear shift schedule. The proactive torque swap allows the torque swap to occur over a longer period of time, at slower rates, and prior to the actual shift command being generated. This reduces or eliminates vehicle stability and driveline oscillation issues, while at the same time allowing the shift to occur in a timely manner once the shift command is generated, since the torque swap phase may be partially or totally completed once the actual shift command is generated.

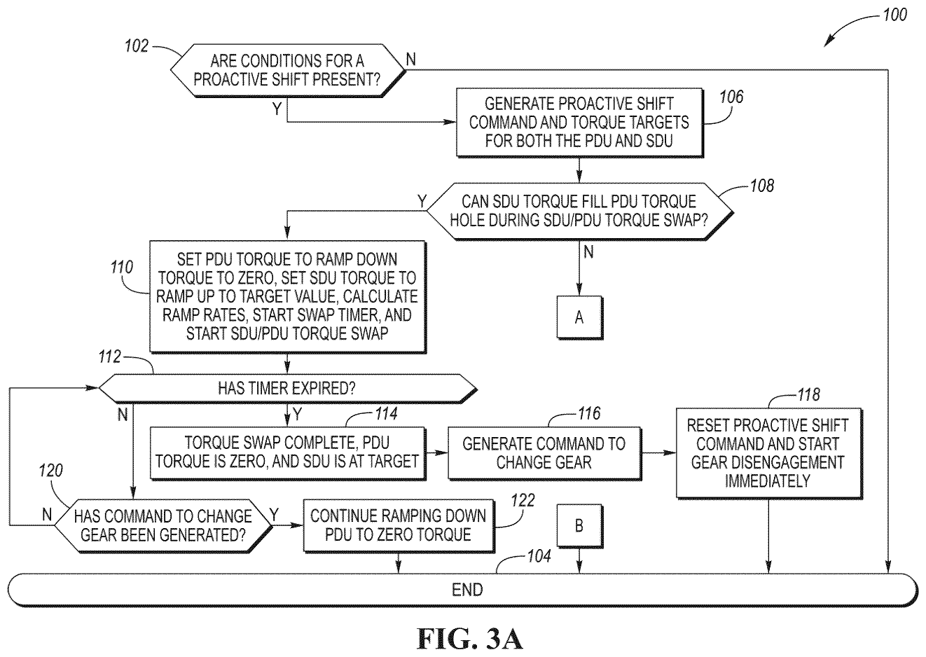

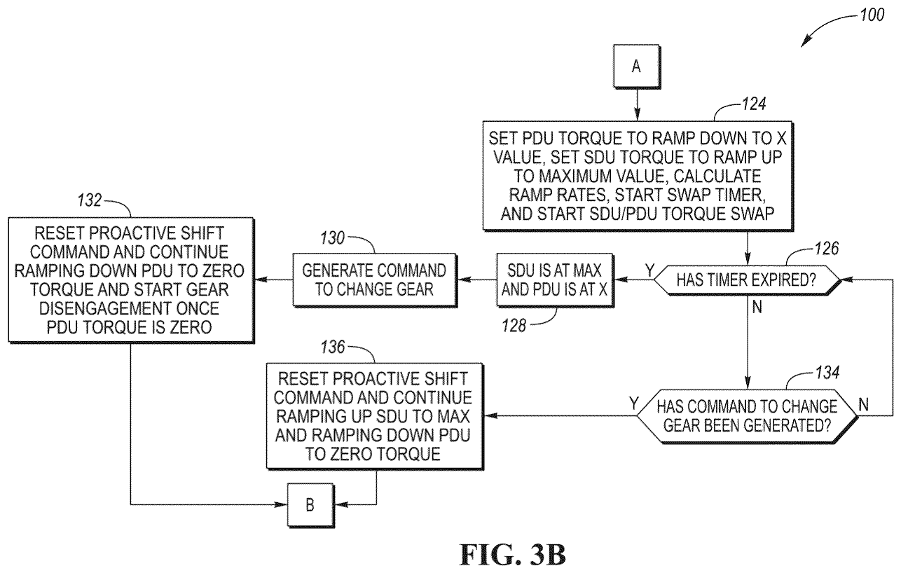

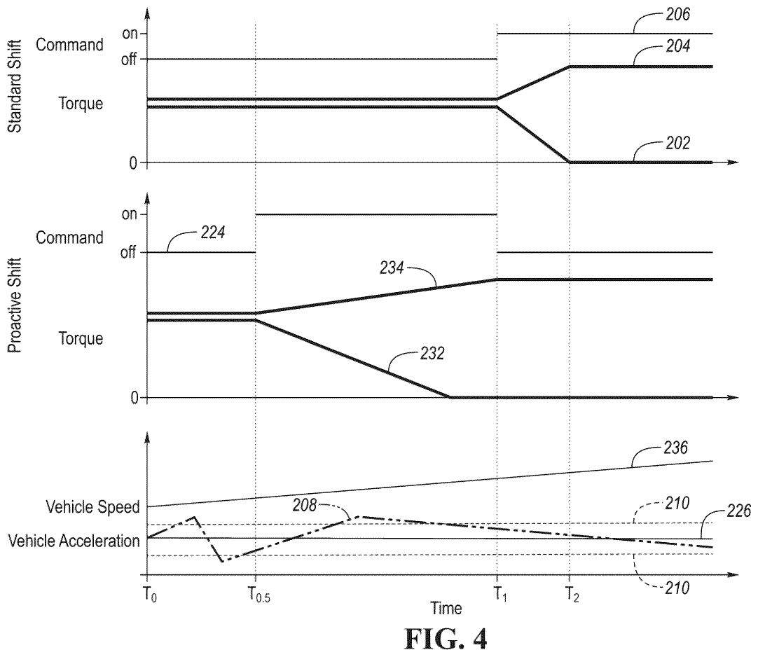

Referring to FIGS. 3A and 3B, a flowchart of a method 100 for controlling the torque outputs of the PDU 14 and the SDU 16 during an upshift in the transmission 22 is illustrated. Also referring to FIGS. 4 and 5, sets of graphs illustrating controlling the torque outputs of the PDU 14 and the SDU 16 during proactive shifts under first and second sets of conditions are illustrated, respectively. More specifically, the method 100 and the graphs in FIGS. 4 and 5 are directed to controlling the torques of the first electric machine 18 and the second electric machine 32 in order to control the wheel torque outputs of the PDU 14 and the SDU 16 (e.g., the torques of drive wheels 20 and drive wheels 34) and compensate for torque holes during the torque swap phase of the shift in the transmission 22. It is noted that the torques of drive wheels 34 may be proportional to the torque of the second electric machine 32 based on the gear ratio of the third set of gears 36. It is further noted that the torques of drive wheels 20 may be proportional to the torque of the first electric machine 18 based on the either the gear ratio of the first set of gears 26 or the second set of gears 28 depending on which set is connected to the output of the transmission 22. The method 100 in FIGS. 3A-3B and the graphs depicted in FIG. 4-7 may be stored as control logic and/or an algorithm within the controller 40. The controller 40 may implement the method 100 by controlling the various components of the vehicle 10.

The method 100 begins at block 102, where it is determined if conditions are present for a proactive shift. More specifically, the conditions that may be required for a proactive shift to occur may include acceleration of the vehicle 10 towards a vehicle speed where an upshift in the transmission 22 is scheduled to occur (e.g., a shift from the first gear to the second gear), a rate of change in a position of an accelerator pedal being less than a threshold rate, a difference between a torque limit of the second electric machine 32 and a current torque of the second electric machine 32 being less than a torque threshold, and an estimated time duration to increase a vehicle speed from a current speed to a threshold speed being less than a time threshold. The threshold speed may correspond to a vehicle speed where a command to upshift the transmission 22 is scheduled to occur. The estimated time duration may be based on the current vehicle speed, the threshold speed, and the current vehicle acceleration. Additionally, the conditions for a proactive shift may include the acceleration of the vehicle remaining within a tolerance or range. The acceleration of the vehicle remaining within the tolerance or range may correspond to a rate of change in a position of the accelerator pedal 42 being less than a threshold rate. On the other hand, the acceleration of the vehicle deviating from the tolerance or range may correspond to the rate of change in the position of the accelerator pedal 42 exceeding than the threshold rate.

If the conditions are not present for a proactive shift at block 102, the method 100 ends at block 104, which may include eventually upshifting the transmission 22, which would be initiated once the vehicle speed reaches the threshold speed where the shift command is generated. This may be referred to as a standard or regular shift. FIGS. 4 and 5 illustrate such a standard shift. The torque output of the PDU 14 (e.g., torque at the drive wheels 20) and the torque output of the SDU 16 (e.g., torque at the drive wheels 34) during a standard shift are illustrated as lines 202 and 204, respectively, in FIGS. 4 and 5. The lines 202 and 204 may alternatively represent the torque outputs of the first electric machine 18 and the second electric machine 32 due to the proportional connections between the first electric machine 18 and the second electric machine 32 and corresponding drive wheels (e.g., drive wheels 20 and drive wheels 34). Also, in FIGS. 4 and 5, the shift command is illustrated as line 206. During a standard shift, the torque output of the PDU (e.g., line 202) and the torque output of the SDU (e.g., line 204) may remain relatively constant as the vehicle speed increases from T₀ toward the threshold speed at time T₁, where the shift command is generated. The torque output of the PDU is then ramped down and while the torque output of the SDU is ramped up during the torque swap phase between times T₁ and T₂ during a standard shift. The off-going clutch of the one or more clutches 30 is then disengaged at time T₂. The remainder of the standard shift then may occur in the same manner as illustrated in FIG. 2.

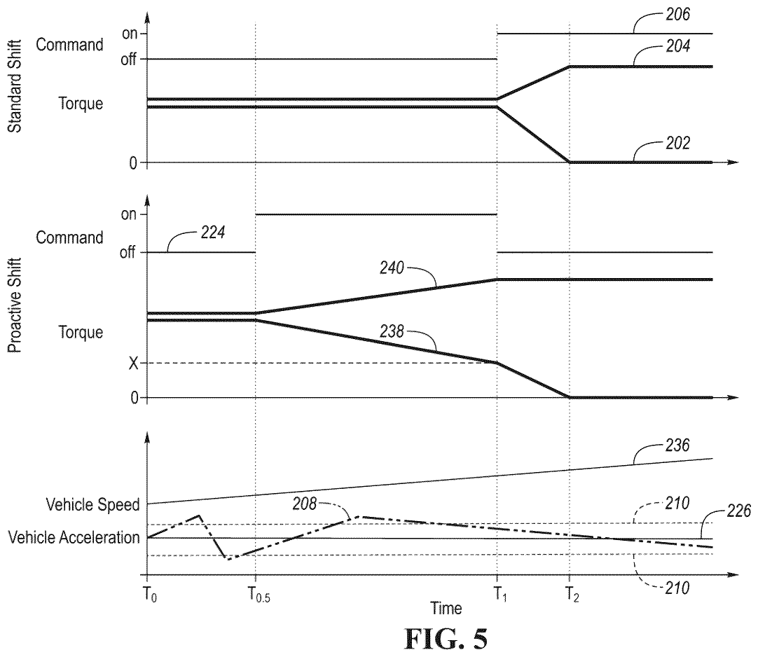

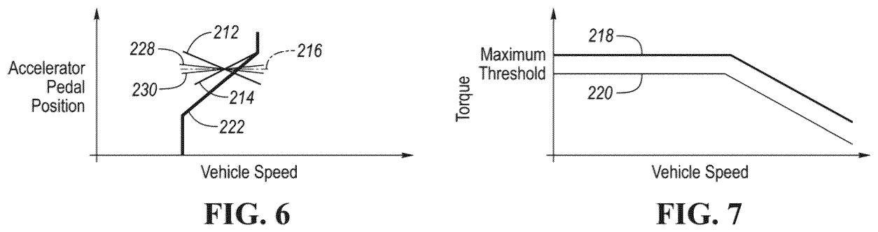

The conditions that may be present that could result in the transmission shifting according to the standard shift due to the method 100 transitioning from block 102 to block 104, may include a vehicle acceleration exceeding a tolerance (e.g., see line 208 in FIGS. 4 and 5, which represents a vehicle acceleration deviating from the tolerance or range where the tolerance or range is bound by lines 210); a rate of change in a position of an accelerator pedal 42 exceeding the threshold rate (e.g., see lines 212 and 214 in FIG. 6, which represent positions of the accelerator pedal 42 relative to vehicle speed, where the rates (or the absolute values of the rates) at which the accelerator pedal position changes exceeding a threshold illustrated by the relatively large slope when compared to a constant accelerator pedal position that has no rate of change, i.e., a zero slope, which is illustrated by line 216); and/or a difference between a torque limit of the second electric machine 32 and a current torque of the second electric machine 32 being less than a torque threshold (this may correspond to the output torque of second electric machine 32 itself or the torque of the SDU 16 falling between a maximum value and a threshold value as illustrated by lines 218 and 220, respectively, in FIG. 7).

It is noted that FIG. 6 further illustrates a shift line 222 and more specifically relates the position of the accelerator pedal 42 relative to the vehicle speed. As the vehicle speed increases and crosses the shift line at various positions of the accelerator pedal 42, the transmission shift from the first gear to the second gear will initiate. When vehicle speed crosses the shift line 222 the shift command may be generated (e.g., see line 206 at time T₁ in FIGS. 4 and 5). It is further noted that FIG. 7 illustrates the output torque of second electric machine 32 itself or the torque output of the SDU 16 (e.g., the torque of the drive wheels 34) relative to vehicle speed.

Returning to FIG. 3A, if the conditions are present for a proactive shift at block 102, the method 100 moves on to block 106, where the proactive shift command is generated (See line 224 between times T_{0.5} and T₁ in FIGS. 4 and 5), and where the target torque outputs for the PDU 14 and SDU 16 (e.g., the torque of drive wheels 20 and drive wheels 34) are generated. Alternatively, the torques of the PDU 14 and SDU 16 may correspond to the torques of the first electric machine 18 and second electric machine 32 throughout the method 100 as described in FIGS. 3A and 3B.

The conditions that may be present that could result in the transmission shifting according to the proactive shift due to the method 100 transitioning from block 102 to block 106, may include a vehicle acceleration remaining within the tolerance (e.g., see line 226 in FIGS. 4 and 5, which represents a vehicle acceleration remaining within the tolerance or range between lines 210); the rate of change in the position of an accelerator pedal 42 remaining within the threshold rate (e.g., see lines 216, 228, and 230 in FIG. 6, which represent positions of the accelerator pedal 42 relative to vehicle speed, where the rates (or the absolute values of the rates) at which the accelerator pedal position changes is less than a threshold, such as a zero slope (e.g., line 216) or the relatively small slope (e.g., line 228 and 230) particularly when compared to the slopes of lines 212 and 214); the difference between the torque limit of the second electric machine 32 and the current torque of the second electric machine 32 being greater than the torque threshold (this may correspond to the output torque of second electric machine 32 itself or the torque output of the SDU 16 (e.g., torque of the drive wheels 34) being less than threshold value as illustrated by line 220 in FIG. 7); and/or the estimated time duration to increase the vehicle speed from the current speed to the threshold speed (e.g., the speed that generates the command to shift the transmission 22 from the first gear to the second gear) being less than the time threshold. It is noted that the various rates of change in the position of the accelerator pedal 42 with respect to the examples illustrated by lines 212, 214, 216, 228, and 230 may correspond to the slopes (or absolute values of the slopes) of lines 212, 214, 216, 228, and 230.

The method 100 next moves on to block 108 where it is determined if the torque output of the SDU 16 is capable of filling the torque hole created during the torque swap phase. If the torque output of the SDU 16 is capable of filling the torque hole created during the torque swap phase, the method 100 moves on to block 110 where torque of the PDU 14 is set to ramp down to zero, the torque of the SDU 16 is set to ramp up to a target value, the torque ramp rates of the PDU 14 and SDU 16 are calculated, a swap timer is started, and the torque swap phase is initiated. The method 100 then moves on to block 112 where it is determined if the swap timer has expired. If the torque swap timer has expired, the method 100 moves on to block 114 where it is determined that torque swap has been completed, the PDU torque is zero, and the SDU torque is at the target. Such a torque swap that is implemented during a proactive shift as illustrated in FIG. 4, between times T_{0.5} and T₁, concludes with the shift command at time T₁. More specifically, torque of the PDU 14 is illustrated as line 232 while the torque of the SDU 16 is illustrated as line 234 in FIG. 4 during the torque swap as implemented by blocks 110, 112, and 114. It is noted that lines 232 and 234 may also or alternatively correspond to the torques of the first electric machine 18 and the second electric machine 32, respectively.

The proactive torque swap, occurring between times T_{0.5} and T₁, when compared to the torque swap of the standard shift, occurring between times T₁ and T₂, occurs over a longer period of time, is initiated at a vehicle speed (e.g., line 236 in FIGS. 4 and 5) that is less than the threshold speed at time T₁ where the shift command is generated and the torque swap of the standard shift is initiated, is initiated at a vehicle speed that is less than the vehicle speed at time T₂ where the one or more clutches 30 of the transmission 22 initiate a gear change (e.g., where the off-going clutch of the one or more clutches 30 is disengaged). It is also noted that the absolute value of the rate at which torque of the PDU 14 ramps down during the torque swap of a standard shift (e.g., the absolute value of the rate or slope of line 202 between times T₁ and T₂) is greater than the absolute value of the rate at which torque of the PDU 14 ramps down during the torque swap of a proactive shift (e.g., the absolute value of the rate or slope of line 232 between times T_{0.5} and T₁). It further noted that the absolute value of the rate at which torque of the SDU 16 ramps up during the torque swap of a standard shift (e.g., the absolute value of the rate or slope of line 204 between times T₁ and T₂) is greater than the absolute value of the rate at which torque of the SDU 16 ramps up during the torque swap of a proactive shift (e.g., the absolute value of the rate or slope of line 234 between times T_{0.5} and T₁). The prolonged duration of the torque swap at lower ramping rates increases vehicle stability and reduces or eliminates driveline oscillation issues. Anticipating the transmission shift and completing the torque swap phase prior to generating the shift command at time T₁, ensures the shift will occur in a quick and timely manner once the shift command is generated.

After block 114, the method 100 moves on to block 116 where the shift command is generated (e.g., see line 206 at time T₁ in FIG. 4). Once the shift command is generated, the method 100 moves on to block 118, where the proactive shift command is reset and the off-going clutch of the one or more clutches 30 begins to disengage at time T₂. After block 118, the method 100 ends at block 104.

Returning to block 112, if the torque swap timer has not expired, the method 100 moves on to block 120, where it is determined if the shift command has been generated (e.g., see line 206 at time T₁ in FIG. 4). If the shift command has not been generated at block 120, the method 100 recycles back to block 112. If the shift command has been generated at block 120, the method 100 moves on to block 122, where the torque of the PDU will continue to be ramped down to zero, which will then be followed by the off-going clutch of the one or more clutches 30 beginning to disengage. The scenario outlined by block 122 may occur in response to a change that necessitates ending the proactive shift (e.g., a large change in vehicle acceleration). After block 122, the method 100 ends at block 104.

Returning to block 108, if the torque output of the SDU 16 is not capable of filling the torque hole created during the torque swap phase, the method 100 moves on to block 124 where torque of the PDU 14 is set to ramp down to a minimal X value, the torque of the SDU 16 is set to ramp up to a maximum value, the torque ramp rates of the PDU 14 and SDU 16 are calculated, a swap timer is started, and the torque swap phase is initiated. The method 100 then moves on to block 126 where it is determined if the swap timer has expired. If the torque swap timer has expired, the method 100 moves on to block 128 where it is determined that the PDU torque is at the minimal X value and the SDU torque is at the maximum value. Such a torque swap that is implemented during a proactive shift as illustrated in FIG. 5, between times T_{0.5} and T₁, concludes with the shift command at time T₁. More specifically, torque of the PDU 14 is illustrated as line 238 while the torque of the SDU 16 is illustrated as line 240 in FIG. 5 during the torque swap as implemented by blocks 124, 126, and 128. It is noted that lines 238 and 240 may also or alternatively correspond to the torques of the first electric machine 18 and the second electric machine 32, respectively.

The proactive torque swap, occurring between times T_{0.5} and T₁, when compared to the torque swap of the standard shift, occurring between times T₁ and T₂, occurs over a longer period of time, is initiated at a vehicle speed (e.g., line 236 in FIGS. 4 and 5) that is less than the threshold speed at time T₁ where the shift command is generated and the torque swap of the standard shift is initiated, is initiated at a vehicle speed that is less than the vehicle speed at time T₂ where the one or more clutches 30 of the transmission 22 initiate a gear change (e.g., where the off-going clutch of the one or more clutches 30 is disengaged). It is also noted that the absolute value of the rate at which torque of the PDU 14 ramps down during the torque swap of a standard shift (e.g., the absolute value of the rate or slope of line 202 between times T₁ and T₂) is greater than the absolute value of the rate at which torque of the PDU 14 ramps down during the torque swap of a proactive shift (e.g., the absolute value of the rate or slope of line 238 between times T_{0.5} and T₁). It further noted that the absolute value of the rate at which torque of the SDU 16 ramps up during the torque swap of a standard shift (e.g., the absolute value of the rate or slope of line 204 between times T₁ and T₂) is greater than the absolute value of the rate at which torque of the SDU 16 ramps up during the torque swap of a proactive shift (e.g., the absolute value of the rate or slope of line 240 between times T_{0.5} and T₁). The prolonged duration of the torque swap at lower ramping rates increases vehicle stability and reduces or eliminates driveline oscillation issues. Anticipating the transmission shift and completing the torque swap phase prior to generating the shift command at time T₁, ensures the shift will occur in a quick and timely manner once the shift command is generated.

After block 128, the method 100 moves on to block 130 where the shift command is generated (e.g., see line 206 at time T₁ in FIG. 5). Once the shift command is generated, the method 100 moves on to block 132, where the proactive shift commanded is reset, the torque of the PDU 14 (e.g., line 238) is further ramped down to zero between times T₁ and T₂, and the off-going clutch of the one or more clutches 30 begins to disengage at time T₂ once the torque of the PDU 14 has reached zero. After block 132, the method 100 ends at block 104.

Returning to block 126, if the torque swap timer has not expired, the method 100 moves on to block 134, where it is determined if the shift command has been generated (e.g., see line 206 at time T₁ in FIG. 5). If the shift command has not been generated at block 134, the method 100 recycles back to block 126. If the shift command has been generated at block 134, the method 100 moves on to block 136, where the proactive shift commanded is reset, the torque of the SDU 16 will be ramped down to the maximum value, the torque of the PDU 14 will be ramped down to zero, which will then be followed by the off-going clutch of the one or more clutches 30 beginning to disengage. The scenario outlined by block 136 may occur in response to a change that necessitates ending the proactive shift (e.g., a large change in vehicle acceleration). After block 136, the method 100 ends at block 104.

It should be understood that the flowchart in FIGS. 3A and 3B is for illustrative purposes only and that the method 100 should not be construed as limited to the flowchart in FIGS. 3A and 3B. Some of the steps of the method 100 may be rearranged while others may be omitted entirely.

It should be understood that the designations of first, second, third, fourth, etc. for any component, state, or condition described herein may be rearranged in the claims so that they are in chronological order with respect to the claims. Furthermore, it should be understood that any component, state, or condition described herein that does not have a numerical designation may be given a designation of first, second, third, fourth, etc. in the claims if one or more of the specific component, state, or condition are claimed.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A vehicle comprising:
first and second electric machines;
a transmission; and
a controller programmed to, for a given vehicle speed at which clutches of the transmission initiate a gear change, initiate adjustment of torques of the first and second electric machines prior to the gear change at a target vehicle speed that is less than the given vehicle speed, wherein the target vehicle speed is greater as a result of vehicle acceleration deviating from a range as compared with the vehicle acceleration remaining within the range.

2. The vehicle of claim 1, wherein the controller is programmed to,
as a result of the vehicle acceleration deviating from the range, adjust the torques of the first and second electric machines over a first time period, and
as a result of the vehicle acceleration remaining within the range, adjust the torques of the first and second electric machines over a second time period that is greater than the first time period.

3. The vehicle of claim 1, wherein the controller is programmed to,
as a result of the vehicle acceleration deviating from the range, adjust the torques of the first and second electric machines at first and second rates, respectively, and
as a result of the vehicle acceleration remaining within the range, adjust the torques of the first and second electric machines at third and fourth rates, respectively.

4. The vehicle of claim 3, wherein an absolute value of the first rate is greater than an absolute value of the third rate.

5. The vehicle of claim 4, wherein an absolute value of the second rate is greater than an absolute value of the fourth rate.

6. The vehicle of claim 1 further comprising an accelerator pedal, and wherein the vehicle acceleration deviating from the range corresponds to a rate of change in a position of an accelerator exceeding a threshold rate.

7. The vehicle of claim 6, wherein the vehicle acceleration remaining within the range corresponds to the rate of change in the position of the accelerator being less than the threshold rate.

8. A vehicle comprising:
first and second electric machines operable to deliver torque to drive wheels;
a transmission operable to deliver the torque from the first electric machine to a first of the drive wheels and having clutches operable to adjust a gear ratio between the first electric machine and the first of the drive wheels; and
a controller programmed to,
as a result of an acceleration of the vehicle deviating from a tolerance, decrease the torque of the first electric machine and increase the torque of the second electric machine at a first vehicle speed that is less than a threshold speed, wherein the threshold speed corresponds to a vehicle speed at which a first of the clutches disengages to initiate a change in the gear ratio between the first electric machine and the first of the drive wheels, and
as a result of the acceleration remaining within the tolerance, decrease the torque of the first electric machine and increase the torque of the second electric machine at a second vehicle speed that is less than the first vehicle speed.

9. The vehicle of claim 8, wherein the controller is programmed to,
as a result of the acceleration deviating from the tolerance, decrease the torque of the first electric machine and increase the torque of the second electric machine over a first time period, and
as a result of the acceleration remaining within the tolerance, decrease the torque of the first electric machine and increase the torque of the second electric machine over a second time period that is greater than the first time period.

10. The vehicle of claim 8, wherein the controller is programmed to,
as a result of the acceleration deviating from the tolerance, decrease the torque of the first electric machine and increase the torque of the second electric machine at first and second rates, respectively, and
as a result of the acceleration remaining within the tolerance, decrease the torque of the first electric machine and increase the torque of the second electric machine at third and fourth rates, respectively.

11. The vehicle of claim 10, wherein an absolute value of the first rate is greater than an absolute value of the third rate.

12. The vehicle of claim 11, wherein an absolute value of the second rate is greater than an absolute value of the fourth rate.

13. The vehicle of claim 8 further comprising an accelerator pedal, and wherein the acceleration remaining within the tolerance corresponds to a rate of change in a position of the accelerator pedal being less than a threshold rate.

14. The vehicle of claim 13, wherein the acceleration deviating from the tolerance corresponds to the rate of change in the position of the accelerator pedal exceeding the threshold rate.

15. A vehicle comprising:
first and second electric machines operable to deliver torque to first and second drive wheels, respectively;
a transmission operable to deliver the torque from the first electric machine to the first drive wheel and shift between first and second gear ratios; and
a controller programmed to,
as a result of (i) an acceleration of the vehicle toward a threshold speed, (ii) a time duration to increase a vehicle speed from a current speed to the threshold speed being less than a time threshold, and (iii) a rate of change in a position of an accelerator pedal being less than a threshold rate, decrease the torque of the first electric machine and increase the torque of the second electric machine prior to the vehicle attaining the threshold speed and shifting the transmission from the first gear ratio to the second gear ratio, and
as a result of (i) the acceleration of the vehicle toward the threshold speed, (ii) the time duration being less than the time threshold, and (iii) the rate of change in the position of the accelerator pedal exceeding the threshold rate, decrease the torque of the first electric machine and increase the torque of the second electric machine upon the vehicle attaining the threshold speed and shifting the transmission from the first gear ratio to the second gear ratio.

16. The vehicle of claim 15, wherein the controller is programmed to,
as a result of decreasing the torque of the first electric machine and increasing the torque of the second electric machine prior to the vehicle attaining the threshold speed, decrease the torque of the first electric machine and increase the torque of the second electric machine over a first time period, and
as a result of decreasing the torque of the first electric machine and increasing the torque of the second electric machine upon the vehicle attaining the threshold speed, decrease the torque of the first electric machine and increase the torque of the second electric machine over a second time period that is less than the first time period.

17. The vehicle of claim 15, wherein the controller is programmed to,
as a result of decreasing the torque of the first electric machine and increasing the torque of the second electric machine prior to the vehicle attaining the threshold speed, decrease the torque of the first electric machine and increase the torque of the second electric machine at first and second rates, respectively, and
as a result of decreasing the torque of the first electric machine and increasing the torque of the second electric machine upon the vehicle attaining the threshold speed, decrease the torque of the first electric machine and increase the torque of the second electric machine at third and fourth rates, respectively.

18. The vehicle of claim 17, wherein an absolute value of the first rate is less than an absolute value of the third rate.

19. The vehicle of claim 18, wherein an absolute value of the second rate is less than an absolute value of the fourth rate.

20. The vehicle of claim 15, wherein the controller is programmed to, as a result of (i) the time duration being less than the time threshold, (ii) the rate of change in the position of an accelerator pedal being less than the threshold rate, and (iii) a difference between a torque limit of the second electric machine and a current torque of the second electric machine being less than a torque threshold, decrease the torque of the first electric machine and increase the torque of the second electric machine upon the vehicle attaining the threshold speed and shifting the transmission from the first gear ratio to the second gear ratio.
